(19) United States
(12) Patent Application Publication
(10) Pub. No.: US 2022/0354046 A1
(43) Pub. Date: Nov. 10, 2022

(54) PNEUMATIC SEED METERS

(71) Applicant: José Roberto do Amaral Assy, Caldas Novas, GO (BR)

(72) Inventors: Jose Roberto do Amaral Assy, Caldas Novas (BR); Fernando Jorge Sanches, Sao Paulo (BR); Ricardo Araujo Pereira, Guarulhos (BR); Guilherme Silva Rodrigues, Guarulhos (BR)

(21) Appl. No.: 17/621,663

(22) PCT Filed: Jul. 1, 2020
(86) PCT No.: PCT/BR2020/050239

§ 371 Date: Dec. 21, 2021

Related U.S. Application Data
(60) Provisional application No. 62/870,675, filed on Jul. 4, 2019.

(51) Int. Cl. A01C 7/10; A01C 7/08; A01C 7/12

(52) U.S. Cl. CPC A01C 7/105; A01C 7/084; A01C 7/128

(57) ABSTRACT

The disclosed pneumatic seed meters for small seeds and fine grains may include a rotational disk with a plurality of radially disposed holes. The holes may define a seed path when the rotational disk rotates. The seed meters may also include a sealing structure that is positioned and configured to inhibit seed leakage from the seed meter. The sealing structure may define a seed containment chamber. Various other related methods, systems, and devices are also disclosed.

### TECHNICAL FIELD

The present disclosure relates, in general, to precision farming. In some embodiments, the disclosure relates to pneumatic meters and seed transport.

### BACKGROUND

Agriculture plays a key role in countries' economies and peoples' livelihoods. Agriculture is responsible for the strength of several economies in the globe, such as importing and exporting businesses or manufacturing industries.

Globalization and high global population growth foster a large world market for agricultural products. To meet the demands and achieve greater profits, farmers have increasingly invested in equipment and technological applications in agricultural implements that provide greater productivity in their plantations.

In large plantations, planters, which are also referred to as “sowing machines,” are often used in order to ensure, with agility, the adequate spacing between planting lines and the uniformity in the deposition of the seeds in the planting grooves at suitable depths.

The proper spacing between the seeds in the soil is one of the main factors that influence crop yield for plantations. Seeds that are very close to each other may result in a greater competition for seeds, such as in obtaining sufficient water, lighting, and nutrients present in the soil. Competition for these resources may limit plant growth, thus reducing the final yield of the crop.

Each agricultural species has certain peculiarities regarding the sowing stage. Therefore, it is often necessary to perform a previous study of the planting parameters of the seeds of the species to be deposited, such as to determine the appropriate distance between the seeds in the soil, depth of the seeds in the planting grooves, and sowing density.

Cultures of small seed species conventionally require greater care in the sowing stage. In general, the deposition of small seeds, such as canola, sorghum, eggplant, sugar beet, and vegetables, is typically more complex than for larger seeds. Accordingly, precision agricultural equipment, such as mechanical seed meters, are often used for sowing such small seeds.

Conventional agricultural equipment, such as pneumatic seed meters, may exhibit certain limitations when operating with small seeds. For example, the small dimensions of the seeds may result in their leakage from the internal portion of the meter. During the sowing stage, this leakage may be a serious problem, since the seeds that leak from the meter can fall into the soil and germinate, sometimes drastically increasing the population density in the regions of leakage and decreasing the final yield of the planting.

Specifically for canola, there is a significant agronomic benefit in planting using a seed meter, in an attempt to achieve the singulation and good distribution of seeds in the soil, since the germination of canola is drastically affected when multiple seeds are in contact with each other.

Planting of canola without the use of a seed meter makes it necessary to predict a seed increment per hectare planted, which is an increase that can reach 100% of the desired plant density. This increase is intended to compensate the reduction in the germination rate resulting from the seeds being distributed in the soil without singularization.

When it comes to precision farming, it is common for a row of multiple pneumatic seed meters to be fed from a main hopper. The seed transportation from this hopper to each seed meter is conventionally done by forcing the seeds through a pipe with an air jet. The pipe connects the main hopper to each seed inlet of each of the seed meters present in the planter.

In large planters, the air-jet conveyor pipe is considered indispensable to transport seeds from the central hopper to each of the seed meters, located in each of the lines, since the gravitational action is not enough to guarantee a constant seed flow over the entire length of the pipe.

Optimization of the air flow used for seed transportation can be a challenge, particularly for small seeds. For example, when the mass of the individual seeds is very small, an abrupt acceleration of the seeds may occur when the seeds reach the air flow. The seeds may travel through the pipe at a high velocity until the seeds reach the seed inlet of the meter. This acceleration and high velocity often causes a turbulent flow of the seeds inside the meter. Such turbulent seed feeding into the seed meter may compromise the proper operation of a pneumatic seed meter. In addition to the difficulty in controlling the flow of the seeds fed into the seed meter, the chaotic movement of the seeds often compromises the singularization of the seeds inside the seed meter, leading to failures (e.g., missing seeds) and/or duplications (e.g., multiple seeds where only one is intended to be present).

Conventional approaches to feeding the meters with seeds from the central hopper without the problems described above include the use of air exhaust elements. For example, some models of air exhaust elements, also called air diffusers, have been developed. These structures are typically used for exhausting the air from the seed supply pipe. For example, such air diffusers are described in U.S. Pat. No. 6,505,569, titled “SEEDER AIRFLOW CONTROL SYSTEM,” dated Jan. 14, 2003, and U.S. Pat. No. 3,964,639, titled “SEED TUBE DIFFUSER FOR A PNEUMATIC SEED PLANTER,” dated Jun. 22, 1976.

These diffuser models are positioned in the seed inlet opening of the meter. In this configuration, the seeds are transported from the outlet of the hopper to the feed inlet of the meter by the action of the air jet, but when the seeds arrive in the opening of the meter by the action of the air jet, the air escapes through the apertures of the diffuser, allowing the seeds to fall into the seed inlet opening of the seed meter.

Although functional for a wide variety of seed types, conventional diffusers are often inefficient, especially when it comes to small seeds or long grains. In many cases, the geometry of the diffuser is not optimized for the passage of air. In addition, the apertures of the diffusers are often ineffective in completely passing the air flow and a portion of the air flow still reaches the inner chamber of the meter, resulting some measure of the problems described above.

In most conventional pneumatic meters, after the seeds pass through the feed inlet, the seeds are stored in a small reservoir within the meter. These reservoirs have the function of provisionally storing the seeds so that they are conveyed in a controlled manner to a singularization chamber of the meter, which is an internal portion of the meter in which the seeds are intended to be singularized (e.g., individually placed) in the holes of a rotational disk.

Some conventional seed meters lack this internal reservoir. In such meters, the seeds fall directly into the singularization chamber after passing through the feed inlet. The meters that lack the internal seed reservoir are more prone to failure and duplications due to the excess of seeds and the chaotic movement of the seeds in the singulation chamber, resulting from the swirling of seeds in the seed feeding stage, as previously described.

One typical way of controlling the level of the inner seed reservoir to encourage the proper operation of the meter involves the use of a conveyor tube connecting the feed inlet to the internal reservoir of the meter. This conveyor tube may include apertures for exhausting the air that is used to convey the seeds to the meter, including air that may enter the meter after passing through a diffuser.

An example of a structure that may function as such a conveyor tube is described in U.S. Pat. No. 7,938,072, titled “AIR PRESSURE DISSIPATOR FOR AIR SEED DELIVERY SYSTEM,” dated May 10, 2011. The described structure includes a tube provided with holes for the passage of air connecting the seed inlet of the meter to an internal seed reservoir. The described perforated tube aims to enable the inner seed reservoir to be supplied to a predetermined level and to prevent this level from being exceeded by the variation of the internal pressure within the tube.

In addition to the problems of seed leakage and seed swirling in feeders, another problem often encountered in pneumatic meters for small seeds concerns malfunctions arising from the presence of debris within the meter. Seed meters for small seeds have corresponding small seed disk holes, also called seed cells, for singulization. The reduced size of the holes in the disk results in a greater risk of obstruction due to possible debris within the meter, such as seed bark, pieces of broken seeds, pieces of leaves and branches, and agglomerates of earth. The introduction of such debris in the holes of the seed disk may preclude the seeds from properly settling therein and, as a consequence, results in failures.

Conventional solutions to problems arising from the presence of internal debris in seed meters include brushes to remove the debris. However, such brushes are typically not very effective for small seed disks, since it is difficult for the brush bristles to effectively penetrate the disk's cells to remove debris. An example of a conventional debris remover is described in U.S. Pat. No. 4,793,511, titled “SEED METER HAVING SEED DISK APERTURE CLEANING WIPER AND BRUSH ARRANGEMENT,” dated Dec. 27, 1988.

Another conventional solution for the removal of debris employs the use of hole cleaners with rosette structures. These hole cleaners remove debris from the disk cells as they traverse the seed path with their tips passing through the disk cells. However, the debris remover tips and the edges of the disk cells may exhibit wear with use. This wear is a consequence of the friction between the tips and the edges of the disk cells, which may result in a low system life.

In addition, another problem encountered in conventional pneumatic meters, when operating to plant small seeds or fine grains, concerns possible errors in releasing seeds from the seed disk. For example, the seeds may be bound in the holes and may, therefore, not come loose. Conversely, the seeds may be released prematurely, causing duplicity and/or failure.

Conventional pneumatic meters customarily operate by means of a pressure difference between the two faces of the seed disk. Most conventional pneumatic meters in the precision planting market are so-called “negative pressure” pneumatic meters. In negative pressure pneumatic meters, the seed disk separates the interior of the meter into two regions on opposing faces of the disk. The difference in pressure between these two regions generates suction forces in the seed cells present on the disk, causing the seeds to be captured in the cells.

In most conventional pneumatic meters, the seeds captured in the disk holes are dislodged by interrupting the low-pressure (e.g., vacuum) condition. There is a region in the meter where there is an opening that exposes that region of the system to atmospheric pressure, thus cutting off the existing vacuum. When the vacuum is cut off, the seeds are released from the disk and are led to the ground by gravitational action, such as through a seed conductor coupled to a seed outlet opening of the meter.

When the pneumatic meter is used for planting small seeds, problems may occur in the seed release operation. Due to the small mass of the small seeds, the seeds may remain lodged within the cells of the disk, even when the vacuum is cut off. There are multiple factors that can cause the seeds to remain within the disk cells, such as electrostatic energy, frictional forces overcoming the weight of the seed, and the seeds becoming mechanically locked in the disk cells.

Some conventional structures have been developed in an attempt to assist in the release of the seeds from the holes of the seed disk. For example, such structures are described in U.S. Pat. No. 7,854,206, titled “SEED METER,” dated Dec. 21, 2010, and U.S. Pat. No. 9,578,798, titled “SCRAPING DEVICE, SEED METER AND SINGLE GRAIN SOWING MACHINE,” dated Feb. 28, 2017.

Thus, conventional pneumatic meters for small seeds may exhibit certain problems, such as seed leaks from their inner portions, compromising the planting arrangement, seed release errors, and low lifespan. These issues may result in higher costs of maintenance and part replacement, inefficiencies, and/or decreased crop yields.

### SUMMARY

The present disclosure is generally directed to a series of improvements for pneumatic seed meters. In some examples, pneumatic seed meters according to the present disclosure may include a rotational disk with a plurality of holes. The holes may define a seed path when the disk rotates. A sealing structure may be positioned and configured to prevent seed leakage and to define a seed containment chamber.

In accordance with some embodiments of the disclosure, the following features, either alone or in technically possible combinations, may also be present: (1) the sealing structure may be coupled to the rotational disk by a support element, forming an integral, unitary device; (2) the sealing structure may include a shell structure provided with a concave chamber, the concave chamber being positioned against the front surface of the rotational disk, defining a seed containment chamber; (3) the sealing structure may include air passages having dimensions smaller than the average seed diameter of the species to be deposited; (4) the sealing structure may be mounted to the meter housing, the housing including a base and a lid; and/or (5) the sealing structure may have sealing elements coupled to its edges, the sealing elements being supported against the front surface of the rotational disk.

In additional embodiments, the present disclosure also relates to a pneumatic meter including a seed feed inlet, with an air exhaust element positioned at the seed feed inlet.

In accordance with further or alternative embodiments of the present disclosure, the following features, either alone or in technically possible combinations, may also be present: (1) the air exhaust element may have an upper aperture perimeter that is larger than a perimeter of the lower aperture; (2) the air exhaust element may include a protective casing; and/or (3) the air exhaust element may have vertical apertures for the airflow output.

Further, the present disclosure relates to a pneumatic meter that may include a seed feed inlet and an internal seed reservoir, wherein the seed feed inlet is connected to the internal seed reservoir via a seed conveyor tube, wherein the inner conveyor tube has apertures for air output.

Another aspect of the present disclosure relates to a pneumatic meter that includes a rotational disk having a plurality of radially disposed holes, the holes defining a seed path when the disk rotates, and a seed ejector disposed on a front face of the rotational disk over a region of the seed path, wherein at least a portion of the seed ejector is located in a low-pressure region.

In accordance with further or alternative embodiments of the present disclosure, the following features, either alone or in technically possible combinations, may also be present: (1) the seed ejector may be interchangeable according to the type of seed to be deposited; (2) the seed ejector may have a curved interface that is positioned on the rotational disk so as to gradually enter the seed path; (3) the curved interface of the seed ejector may have a predefined geometry corresponding to the circular path the seed path; (4) at least a portion of the seed ejector may be located in the low-pressure region, such as being located in a bordering region of the low-pressure region; (5) the seed ejector may be located in a region of transition from the low-pressure region to a seed release region; (6) the seed ejector may be located in the seed release region; and/or (7) the seed ejector may be associated with the rotational disk via a guide system.

In additional embodiments, the present disclosure also relates to a pneumatic meter that may include a rotational disk having a plurality of radially disposed holes in a peripheral region of the rotational disk, and a debris remover provided with protrusions, each protrusion complementary to at least a portion of the shape of the holes of the rotational disk, and each protrusion provided with a tip made of abrasion resistant material.

According to further or alternative embodiments of the present disclosure, the following features, either alone or in technically possible combinations, may also be present: (1) the tip of the debris remover may be angled; (2) the tip of the debris remover may be curved; (3) the tip of the debris remover may traverse the hole of the rotational disk; (4) the tip material may be a metal or a ceramic; (5) each tip may be attached in the debris remover; (6) the tips of the debris remover may be interconnected by a scaffold structure, which may be located inside the debris remover; (7) each tip may be made of the same material as the debris remover; (8) the tips of the debris remover may have a diameter at least 10% smaller than the diameter of the holes of the rotational disk; (9) the diameter of the holes of the rotational disk may be in a range of about 0.5 mm to about 2 mm; and/or (10) the diameter of the holes of the rotational disk may be sized for capturing small seeds or fine grains, such as canola seeds.

### BRIEF DESCRIPTION OF THE DRAWINGS

The accompanying drawings illustrate a number of example embodiments and are a part of the specification. Together with the following description, these appendices demonstrate and explain various principles of the present disclosure.

FIG. 1 is a rear perspective view of a seed meter, according to at least one embodiment of the present disclosure.

FIG. 2 is a front perspective view of the seed meter with a lid thereof open, according to at least one embodiment of the present disclosure.

FIG. 3 is a front perspective view of a sealing member of a seed meter, according to at least one embodiment of the present disclosure.

FIG. 4 is a rear perspective view of the sealing member, according to at least one embodiment of the present disclosure.

FIG. 0.5 is a partial cross-sectional view of an assembly of seed meter, including a sealing element, a rotational disk, and a sealing structure, according to at least one embodiment of the present disclosure.

FIG. 6 is a cross-sectional view of an air exhaust element positioned on the rotational disk and showing a seed containment chamber, according to at least one embodiment of the present disclosure.

FIG. 7 is an upper perspective view of the air exhaust element, according to at least one embodiment of the present disclosure.

FIG. 8 is a lower perspective view of the air exhaust element, according to at least one embodiment of the present disclosure.

FIG. 9 is a longitudinal section view of the air exhaust element, according to at least one embodiment of the present disclosure.

FIG. 10 is an upper perspective view of a protective casing of the air exhaust element, according to at least one embodiment of the present disclosure.

FIG. 11 is an exploded view of the air exhaust element and corresponding protective casing, according to at least one embodiment of the present disclosure.

FIG. 12 is a side view of an inner conveyor tube, according to at least one embodiment of the present disclosure.

FIG. 13 is a front view of the inner conveyor tube, according to at least one embodiment of the present disclosure.

FIG. 14 is a perspective view of an assembly including the inner conveyor tube, the rotating disk, and the sealing structure, according to at least one embodiment of the present disclosure.

FIG. 15 is a perspective view of an assembly including the inner conveyor tube and a portion of a seed meter housing, according to at least one embodiment of the present disclosure.

FIG. 16 is an upper perspective view of a seed ejector, according to at least one embodiment of the present disclosure.

FIG. 17 is a lower perspective view of the seed ejector, according to at least one embodiment of the present disclosure.

FIG. 18 is an upper perspective view of an assembly including the rotational disk and the seed ejector, according to at least one embodiment of the present disclosure.

FIG. 19 is an enlarged view of the seed ejector mounted on the seed disk, according to at least one embodiment of the present disclosure.

FIG. 20 is an enlarged view of the seed ejector positioned at least partially in an interface region between a vacuum region and a non-vacuum region, according to at least one embodiment of the present disclosure.

FIG. 21 is an enlarged view of the seed ejector positioned within the vacuum region, according to at least one embodiment of the present disclosure.

FIG. 22 is an enlarged view of the seed ejector positioned within the non-vacuum region, according to at least one embodiment of the present disclosure.

FIG. 23 is a perspective view of a debris remover, according to at least one embodiment of the present disclosure.

FIG. 24 is a perspective view of an assembly including the rotational disk and debris remover positioned on a rear face of the rotational disk, according to at least one embodiment of the present disclosure.

FIG. 25 is a longitudinal section view of the debris remover with tips thereof inserted in corresponding holes of the rotational disk, according to at least one embodiment of the present disclosure.

FIG. 26 is a front view of the debris remover with tips curved radially, according to at least one embodiment of the present disclosure.

FIG. 27 is a front view of the debris remover with tips angled radially, according to at least one embodiment of the present disclosure.

FIG. 28 is a front view of the debris remover with tips curved axially, according to at least one embodiment of the present disclosure.

FIG. 29 is a front view of the debris remover with tips angled axially, according to at least one embodiment of the present disclosure.

FIG. 30 is a side view of an inner portion of a debris remover having a metal frame, according to at least one embodiment of the present disclosure.

FIG. 31 is a side view of a crimping structure of the debris remover tips in a spherical variant, according to at least one embodiment of the present disclosure.

FIG. 32 is a side view of a crimping structure of the debris remover tips in a textured variant, according to at least one embodiment of the present disclosure.

### DETAILED DESCRIPTION OF EXAMPLE EMBODIMENTS

The present disclosure will now be described with respect to certain example embodiments, with reference to the accompanying drawing figures. In the figures and the following description, like parts are marked with like reference numerals. The figures are not necessarily to scale, and certain features of the present disclosure may be shown in an exaggerated scale or in some schematic way. Additionally, details of conventional elements may not be shown in order to more clearly and concisely illustrate features of this disclosure.

Embodiments of the present disclosure are susceptible to implementation in a variety of different ways. Specific embodiments are described in detail and shown in the figures, with the understanding that the description is to be regarded as an exemplification of the principles disclosed herein. These specific embodiments are not intended to limit the present disclosure only to what is illustrated and described. It will be recognized that the different teachings of the embodiments discussed below may be employed separately or in any suitable and technically feasible combination to produce the same or similar technical effects.

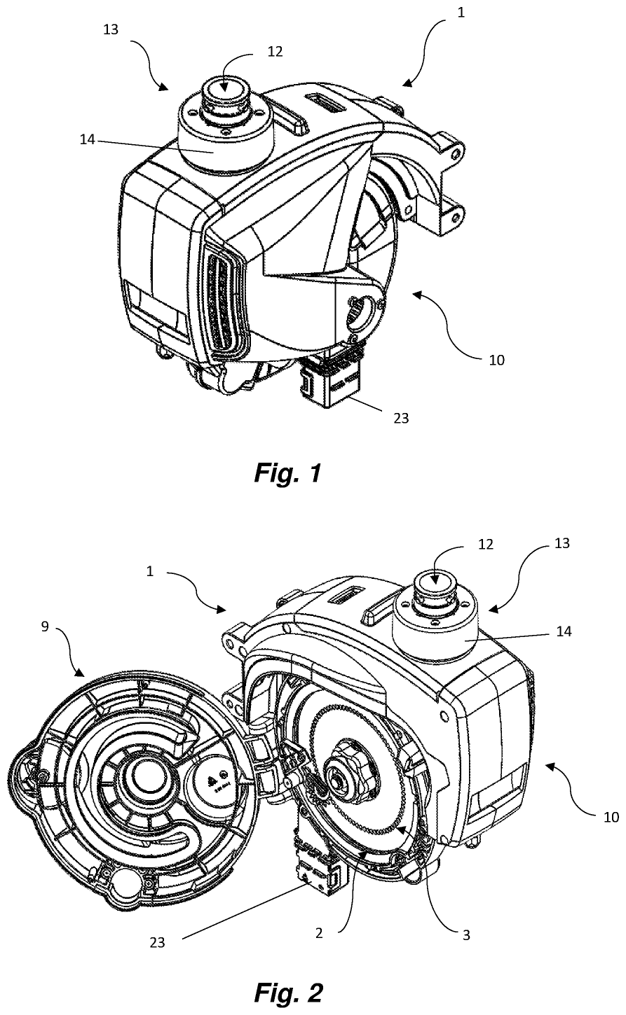

The present disclosure relates to pneumatic seed meters, which may use pneumatic systems for capturing seeds in holes of a rotational seed disk, leading the seeds to a position where the airflow is cut, causing the seeds to fall (e.g., by gravity) once the seeds are withdrawn from the holes and to be directed to planting grooves in soil. FIGS. 1 and 2 show a pneumatic seed meter 1 according to some embodiments of the present disclosure in a closed state and open state, respectively.

In general, the feeding of these seed meters with seeds from a central hopper is accomplished by pipes that connect an outlet opening of the central hopper to a seed supply opening 12 of the seed meter 1. In these pipes, a jet of air may be used to drag the seeds from the hopper to the seed meter 1, causing the seeds to accelerate and travel at a high velocity, which may conventionally result in the troubles of seed turbulence inside the seed meter 1 (absent the provision of certain counteracting elements described herein).

In order to inhibit (e.g., reduce or eliminate) the problems arising from the excess of airflow into seed meters 1 during the seed supply operation, the seed meter 1 of the present disclosure may include an air exhaust element 13 connected to the feed inlet 12 of the seed meter 1, as shown in the FIGS. 1, 2, and 7-11.

Referring to FIGS. 7-11, the air exhaust element 13 may include a hollow structure provided with vertical apertures 15 in its sidewall, the dimensions (e.g., lateral width) of which are smaller than the average diameter of the seeds of the species to be deposited by the seed meter 1. Such apertures 15 in the air exhaust element 13 may be configured, positioned, and dimensioned to allow passage of air through the sidewall of the air exhaust element 13 while inhibiting the passage of seeds through the sidewall and thus into undesired regions of the seed meter 1.

The air exhaust element 13 of the present disclosure may have a particular geometry that is configured to direct airflow outwardly while maintaining seed flow into the seed meter 1. For example, as shown in FIGS. 8 and 9, the perimeter of an upper aperture 16 of the exhaust element 13, which is intended to receive seeds from the hopper through the seed conveyor pipe, may be larger than the perimeter of a lower aperture 17, which is coupled to the feed inlet 12 of the seed meter 1. In some examples, the upper aperture 16 may be circular and the lower aperture 17 may be generally rectangular. In other words, at least a portion of a sidewall of the air exhaust element 13 may be non-parallel, such as having funnel geometry, but not necessarily with a circular base.

The non-parallel geometry of the air exhaust member 13 may increase a surface area of the sidewall of the air exhaust member 13, compared to a parallel geometry. The increased surface area of the sidewall may provide a larger area for the vertical apertures 15, which may result in a larger portion of air escaping through the vertical apertures 15 of the air exhaust element 13.

In addition, the non-parallel shape of the air exhaust member 13 may enable the airflow to be directed out through the vertical apertures 15 because of the natural tendency of the airflow to proceed along the surface of the conductor, to terminate in the vertical apertures 15, and to follow the outer surface of the air exhaust element 13.

In some embodiments of the present disclosure, the air exhaust element 13 may include a protective casing 14 positioned over at least a portion of the body of the air exhaust element 13 (e.g., over a region where the vertical apertures 15 are located), as shown in FIGS. 9-11.

This protective casing 14 may serve as a cover for the air exhaust element 13, having the function of protecting the air exhaust element 13 against mechanical shocks and against the entry of foreign bodies, such as: small bugs, dust, sand, dirt, agglomerates of earth, or pieces of branches or leaves. In addition, the protective casing 14 of the air exhaust element 13 may also prevent direct entry of water (e.g., from rainfall or washing of the equipment) into the seed meter 1 through the supply opening 12.

In addition to the air exhaust element 13, the seed meter 1 may also include an inner seed conveyor tube 18, shown in FIGS. 12 and 13. This inner conveyor tube 18 may interconnect the seed feed inlet 12 of the seed meter 1 to an internal seed reservoir 32 (shown in FIGS. 5, 6, and 14) of the pneumatic seed meter 1. The assembly of the inner seed conveyor tube 18 to other components of the seed meter 1 is shown in FIGS. 14 and 15.

The presence of an internal seed reservoir 32 may facilitate the controlled release of seeds into a seed containment chamber 6 (see FIG. 6), which may be a location where seeds are held for singulation by the rotational disk 2. Without the internal seed reservoir 32, the seeds would fall directly in a seed singulation chamber, increasing the chances of failures and duplicated seeds as a consequence of the turbulent movement of the seeds inside the seed singulation chamber.

The inner conveyor tube 18 of the present disclosure may include a tubular structure provided with apertures 19 in its walls for exhausting air. This inner conveyor tube 18 may function to regulate a level of seeds within the internal seed reservoir 32 of the seed meter 1.

The inner conveyor tube 18 may reduce the volume of seeds stored within internal chambers of the seed meter 1. This may facilitate handling and cleaning of the seed meter 1, as the amount of seeds to be removed in these cases is less.

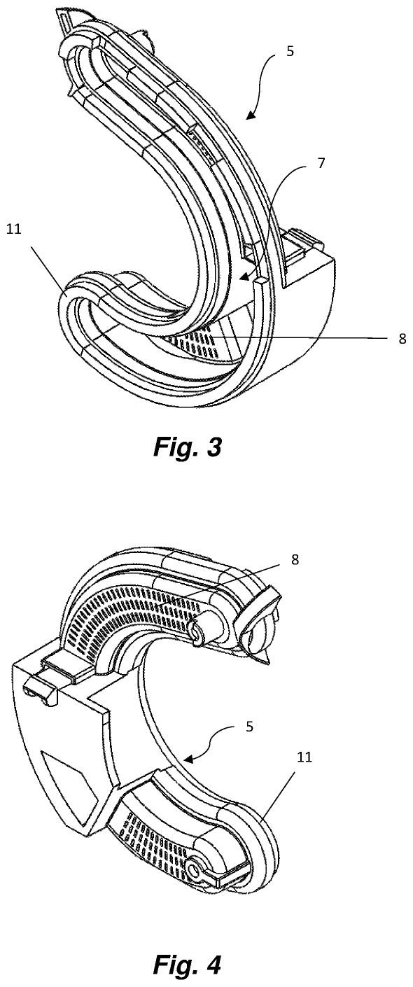

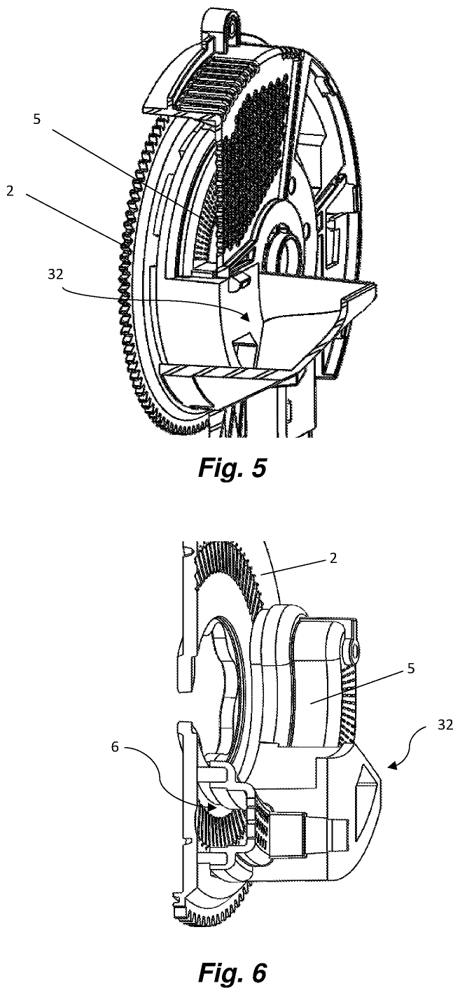

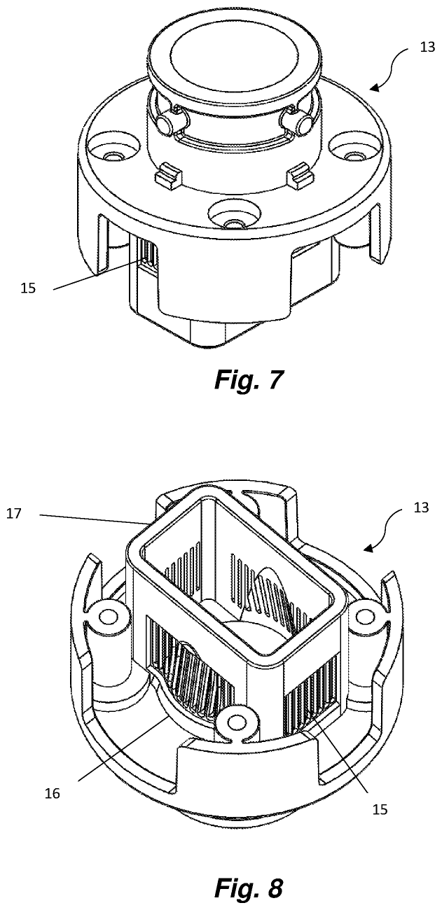

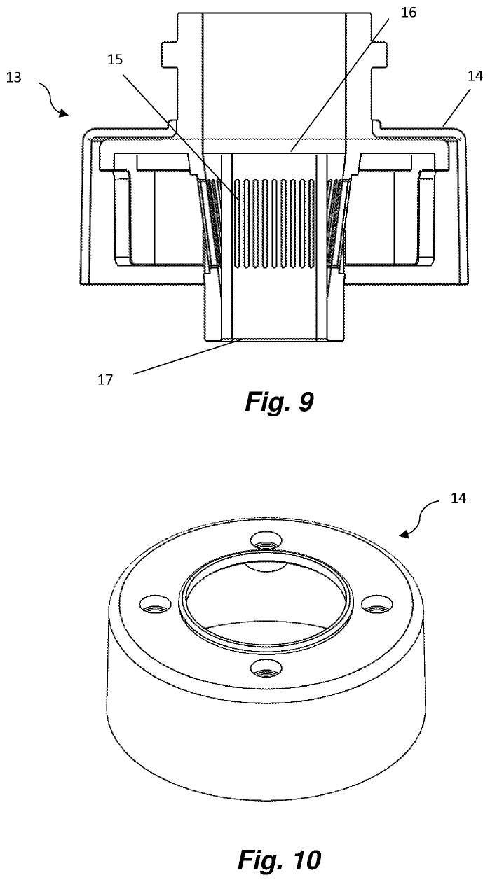

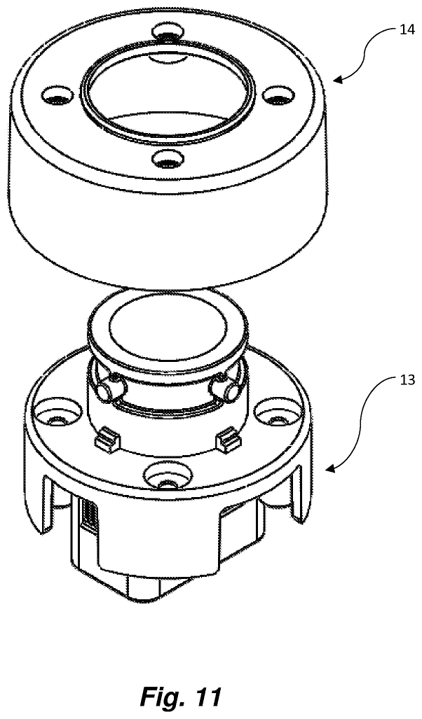

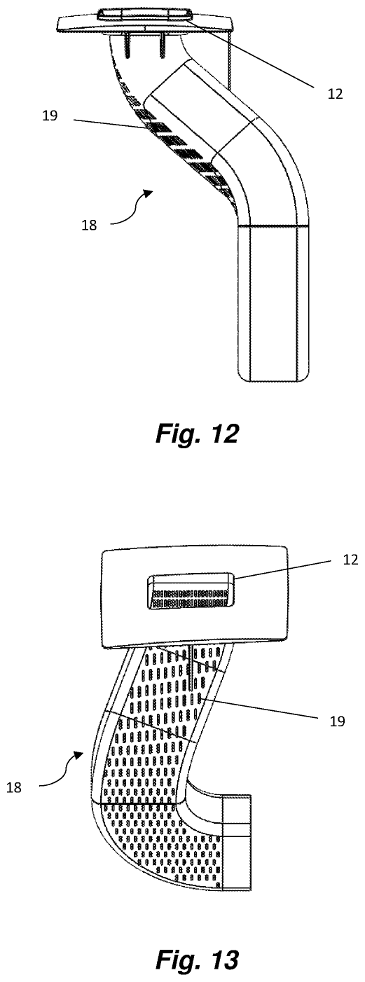

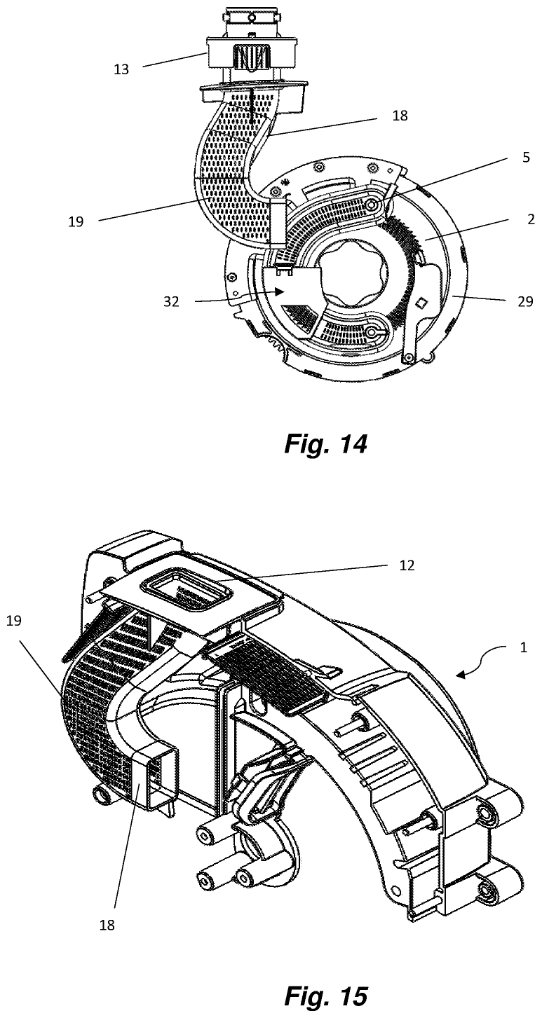

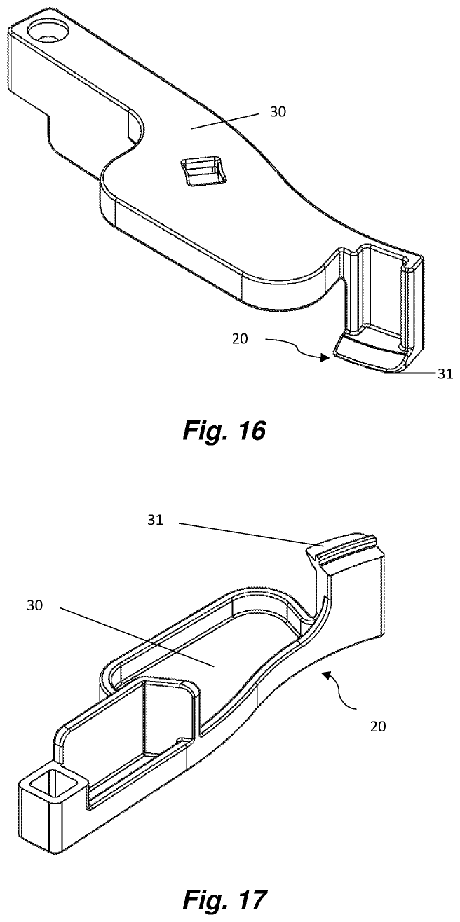

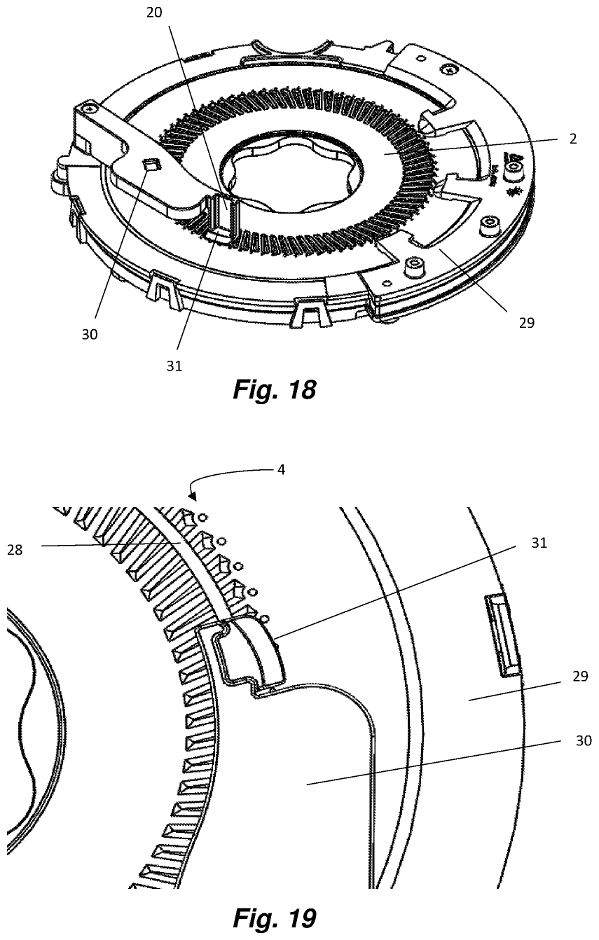

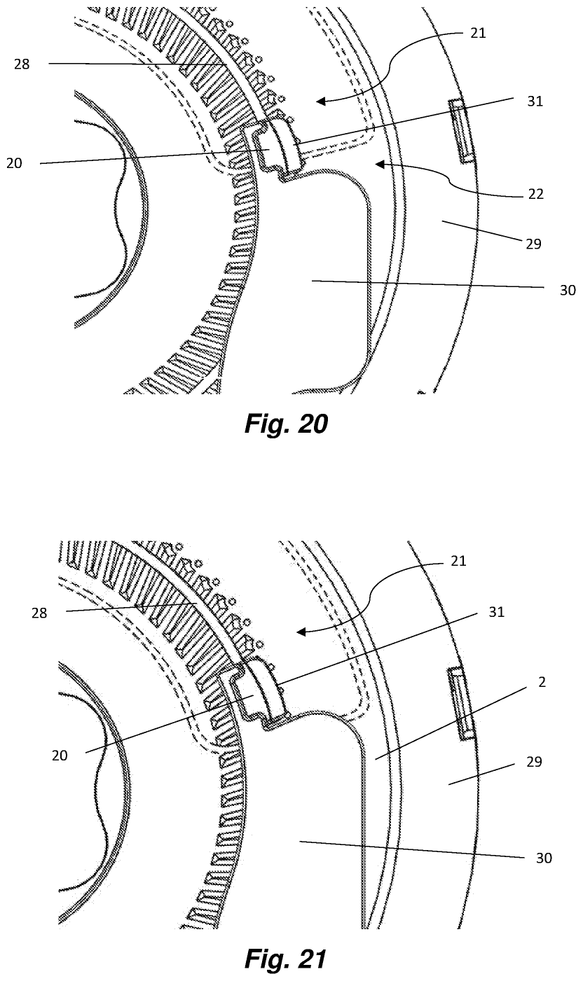

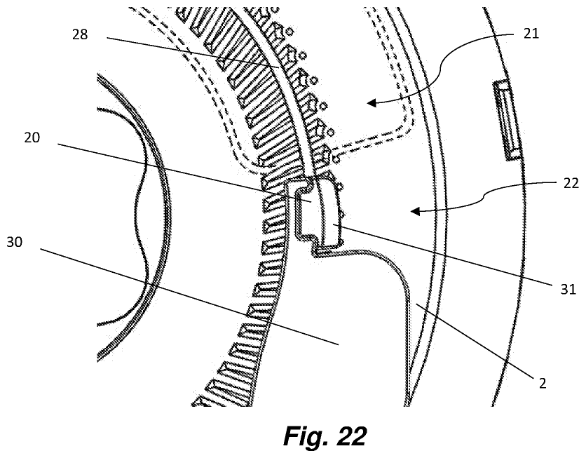

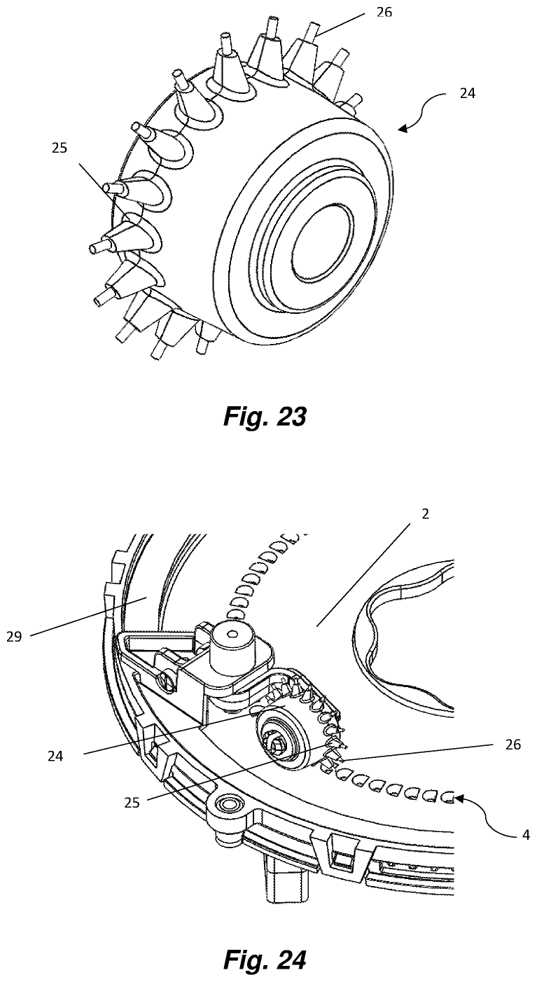

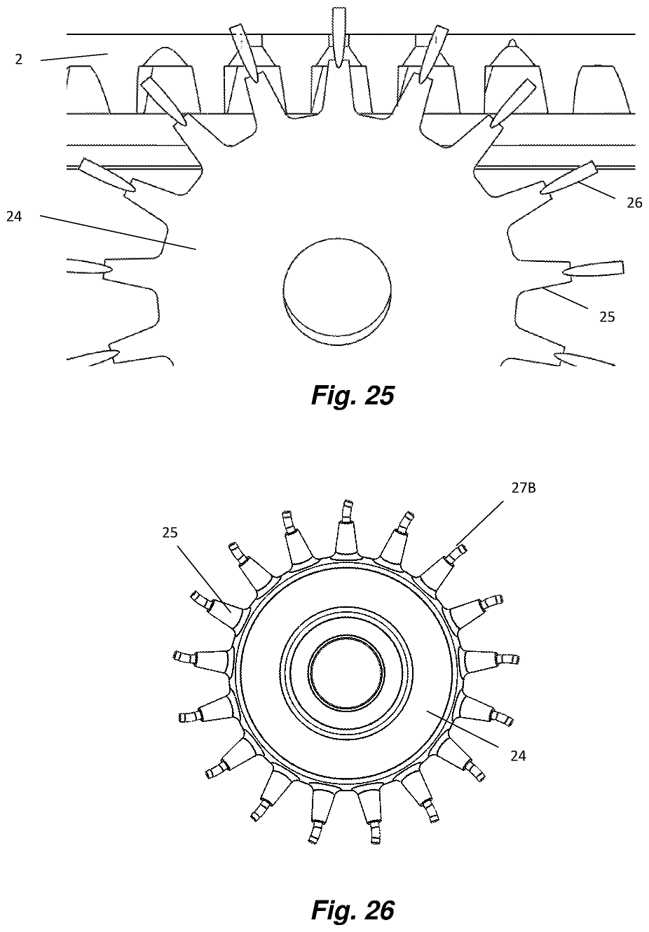

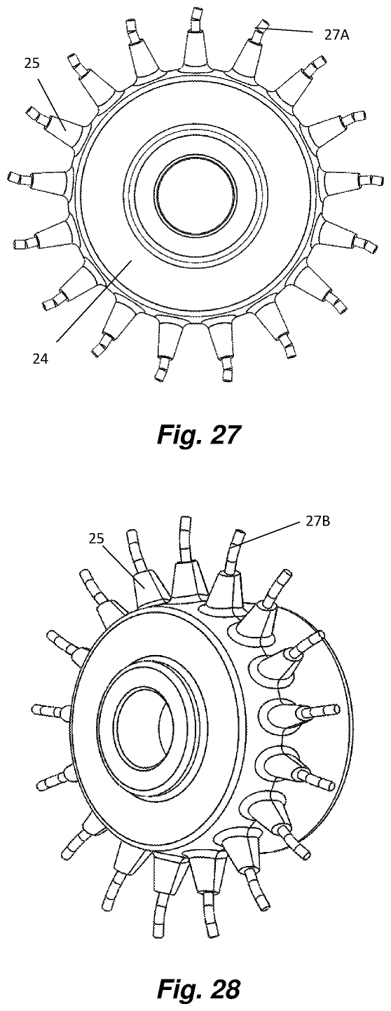

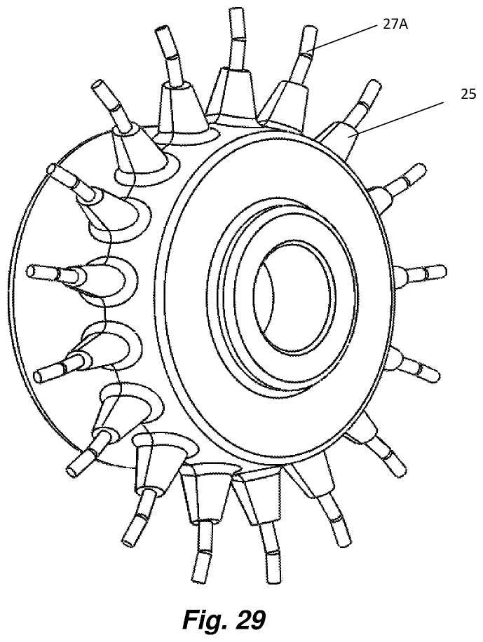

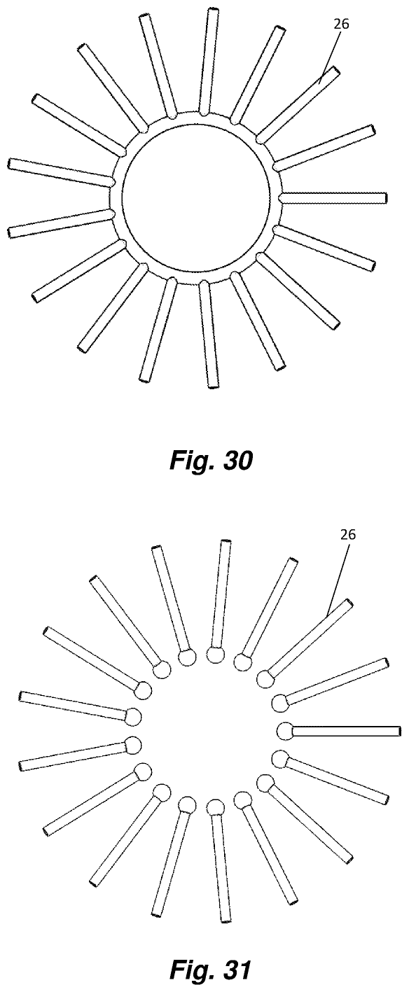

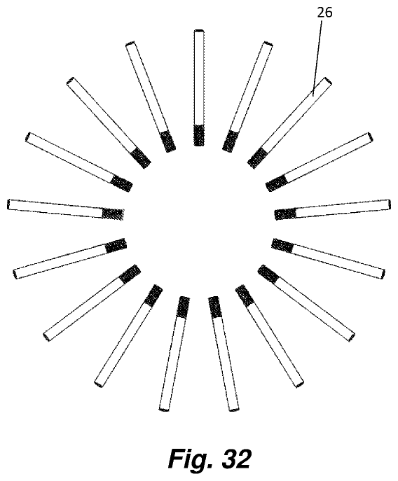

The pneumatic seed meter 1 of the present disclosure may also inhibit seed leakage, which is often a problem in conventional seed meters that are used to deposit small seeds. The leaks may be inhibited (e.g., reduced or eliminated) by employing an inner sealing structure 5 (shown in FIGS. 3 and 4), which may be configured to act in conjunction with the rotational disk 2. The sealing structure 5 may be installed inside the singulation chamber and against the rotational disk 2. The seed containment chamber 6 may be defined by an interior of the sealing structure 5 and a front surface of the rotational disk 2.

This sealing structure 5 may be shaped as a shell structure provided with a concave chamber 7, which may be installed toward the front face of the rotational disk 2. The sealing structure 5 may have air inlet holes 8, the inner dimensions of which may be smaller than the average seed diameter of the species to be deposited. The sealing structure 5 may be fixed to the meter housing within in the inner portion (e.g., singularization chamber) of the meter housing. The sealing structure 5 may be positioned and oriented to remain substantially parallel to the front face of the rotational disk 2.

In some embodiments, the rotational disk 2 may be supported within the seed meter 1 by a support structure 29 (see, e.g., FIG. 18) including an upper support and a lower support. The rotational disk 2 may be located between these two supports. A system of guides on the support structure may constrain movement of the rotational disk to rotational movement. In such examples, the sealing structure 5 may be coupled to the support structure 29 to form a single assembly that may be removed from the seed meter and replaced as a whole unit.

In additional embodiments of the present disclosure, the sealing structure 5 may be a part that is separate from the support structure 29 and rotational disk 2. In this example, the sealing structure 5 may be installed in the seed meter 1 by coupling the sealing structure 5 to a meter housing of the seed meter 1.

As noted above, the sealing structure 5 may act in conjunction with the seed disk 2 to define the seed containment chamber 6, as is shown in FIG. 5. Resilient sealing elements 11 (FIGS. 3 and 4) of the sealing structure 5 may be coupled to peripheral edges of the sealing structure 5. The sealing elements 11 may be or include bristles, fibers, felts, and/or elastomeric materials. The sealing elements 11 may be in contact with the front surface of the rotational disk 2, inhibiting the occurrence of seeds passing through the interface between the edges of the sealing structure 5 and the front face of the rotational disk 2 when the rotational disk 2 is rotated.

In some embodiments of the present disclosure, the seed meter 1 may include debris remover 24, variants of which are shown in FIGS. 23-29. The debris remover 24 may provide a solution for the problem of holes becoming obstructed with debris. The debris remover 24 may be a rosette-type debris remover 24. The debris remover 24 may be configured to efficiently remove debris from small holes, such as the holes 3 of the rotational disk 2 that may be sized for containing small seeds.

The debris remover 24 may function similar to a gear, such that the distances between one tip 26 of the debris remover 24 and an adjacent tip 26 coincide with the distance between the holes 3 of the rotational disk 2. By synchronizing rotation of the rotational disk 2 with the rotation of the debris remover 24, the tips 26 of the debris remover 24 may enter the holes 3 of the seed disk 2 to remove debris as illustrated in FIG. 23.

Particularly, the tips 26 of the debris remover 24 may traverse (e.g., pass through) the holes 3 of the rotational disk 2 completely, thereby ensuring the removal of debris deposited therein.

In some examples, the debris remover 24 may include tips 26 of a small cross-section in the shape of curved rods. The tips 26 may be curved in the direction of rotation of the debris remover 24, as shown in FIG. 26. In additional embodiments, the tips 26 may be rods provided a base portion and an end portion, with the end portion angled relative to the base portion. The angle may be in the direction of rotation of the debris remover 24, as is shown in FIG. 27.

The curvature 27B or angles 27A of the tips 26 may allow a better engagement between the tips 26 and the holes 3 of the rotational disk 2. The curvature 27B or angles 27A may reduce the friction between the tips 26 and the rotational disk 2, which may increase the lifespan of the rotational disk 2 and of the debris remover 24. In addition, there is a greater chance of removal of any materials trapped within the holes 3 of the rotational disk 2, as a result of the curvature 27B or angles 27A, since the tips 26 may be initially directed into the holes 3 as the rotational disk and the debris remover 24 are rotated.

Alternatively or additionally, the tips 26 may also be curved or angled towards the axis of the debris remover 24, so that when the debris remover 24 is mounted on the rotational disk 2, the curvature or angle of the tips 26 direct the tips 26 toward a center of the rotational disk 2 to compensate for the curvature of the rotational disk 2, as respectively shown in FIGS. 28 and 29. This configuration may improve the positioning of the debris remover 24 on the surface of the rotational disk 2.

In some embodiments, in order to provide a longer lifespan to the equipment and to reduce the occurrence of failures, the rosette-type debris remover 24 may include protrusions 25 to hold the base portions of the tips 26. The tips 36 may include an abrasion-resistant material, such as one or more of steel, hard metal alloys, high-hardness ceramics, and/or another material exhibiting a similar abrasion resistance.

The rod-shaped geometry of the tips 26 may allow the tips 26 of the debris remover 24 to have a considerably smaller cross-section than conventional wiper tips. This geometry may enable the tips 26 to transverse (e.g., pass through) the holes 3 in the rotational disk 2 to improve the removal of potential debris deposited therein.

In some embodiments, the rotational disk 2 and the rosette-type debris remover 24 may be sized, shaped, and configured for canola planting. For example, the holes 3 of the rotational disk 2 may have a diameter of between about 0.5 mm and about 2.0 mm, and the tips 26 may have a diameter that is at least about 10% smaller than the corresponding holes 3. In one example, the holes 3 may have a diameter of approximately 1 mm and the tips 26 may have a cross-sectional diameter slightly smaller than the diameter of the disk holes, such as approximately 0.9 mm.

In some embodiments of the present disclosure, the tips 26 of the debris remover 24 may be held in their corresponding protrusions 25 by means of anchoring structures, such as balls, hooks, bosses, and/or recesses, as shown in FIGS. 31 and 32. In additional examples, the tips 26 of the debris remover 24 may be interconnected by a scaffold structure, as shown in FIG. 30.

In some embodiments, the rosette-type debris remover 24 may include a body made of the same material (e.g., an abrasion-resistant material) of the tips 26.

As discussed above, the tips 26 of the debris remover 24 may have a curved or angled configuration in the direction of rotation of the rotational disk 2. This curved or angled configuration may reduce a wear of the disk holes and/or of the tips 26 by allowing the tips 26 to enter and/or pass through the holes 3 more accurately and with reduced contact with the edges of the holes 3.

In addition, the seed meter 1 of the present disclosure may achieve improvements related to the operation of releasing seeds from the rotational disks 2 of pneumatic seed meters 1. Thus, in some embodiments, the seed meter 1 of the present disclosure may employ a seed ejector 20, shown in FIGS. 16-22.

In some examples, the seed ejector 20 may be interchangeable (e.g., removable and replaceable) and may therefore be susceptible to variations and adaptations depending on the type (e.g., size) of seed to be planted.

Conventional seed ejectors are typically positioned in the portion seed meters where there is no applied vacuum. In other words, such conventional structures often act as drivers for the seeds after they have dislodged from the rotational disk, exerting little or no mechanical action on the seeds to help in their release of the seed disk.

In some embodiments, the seed ejector 20 of the present disclosure may be sized and positioned to mechanically release the seeds from the holes 3 of the rotational disk 2 by contacting the seed when the seed is still under the influence of an applied vacuum in a vacuum region 21 (FIGS. 20-22) until the moments after the vacuum is cut (e.g., in a non-vacuum region 22).

The seed ejector 20 of the present disclosure may include an arched surface 32, in which there may be a recess throughout the extent of its outer curvature. The seed ejector 20 may have a geometry similar to that of a knife.

The seed ejector 20 may be positioned on the front face of the rotational disk 2 and, in some embodiments, may be held in a pre-defined position by a guide system 28 (e.g., a protrusion and a corresponding groove) existing at an interface between the seed ejector 20 and the rotational disk 2 (FIGS. 19-22). However, in additional embodiments, such a guide system 28 may be omitted (e.g., as shown in FIG. 18).

The outer curvature of the seed ejector 20 may have a specific geometry to match its performance to the circular trajectory of the seeds on the disk. With the curved geometry, the seed ejector 20 may be positioned to gradually enter the seed path 4 of the rotational disk 2, covering the area of the holes 3 in a linear way and avoiding the abrupt decoupling of the seeds from the holes 3.

In some examples, the guide system 28 of the seed ejector 20 may include a recess on the front face of the seed disk 2 (seed deposition face) and the seed ejector 20 may have a corresponding protuberance at its end (see FIG. 31). This protuberance may be positioned within a path defined by the recess, which may also serve as a support for the seed ejector 20 as the rotational disk 2 rotates.

In additional embodiments, the guide system 28 of the seed ejector 20 may include an extension on the front surface of the rotational disk 2. A cavity at the end of the seed ejector 20 may be complementary to the extension, allowing for the accurate placement of the seed ejector 20 as the rotational disk 2 rotates. For example, the extension of the guide system 28 may include a pin or rail and/or combinations of pins and/or rails arranged radially. In addition, the extension of the guide system 28 may be continuous along its circumference.

In some embodiments, at least a portion of the seed ejector 20 may be positioned within the low-pressure region 21 (“vacuum”) of the meter 1. This configuration may ensure that the seed will be pushed out of the disk hole as the seed ejector 20 enters the seed path 4 even if the seed remains attached to the hole 3 of the rotational disk 2 after the vacuum has been cut off. Another, different portion of the seed ejector 20 may be located within a region where there is no vacuum, which may ensure the gradual removal of the seeds from the hole 3. This configuration for the seed ejector 20 is illustrated schematically in FIG. 20.

In some embodiments, the seed ejector 20 may be positioned on the front face of the rotational disk 2 via an arm 30. The arm 30 may connect the seed ejector 20 to some attachment point in the meter structure, in addition to or in lieu of the aforementioned guide system 28. For example, as shown in FIG. 18, the arm 30 may be attached (e.g., removably attached) to the support structure 29. Alternatively, the arm 30 may be attached (e.g., removably attached) to a meter housing.

In additional examples, the seed ejector 20 may be fully positioned in the low-pressure region 21, as shown in FIG. 21.

In additional examples, as illustrated in FIG. 22, the seed ejector 20 may be positioned in a seed release region 22, where there is no applied vacuum and the seeds are over the seed exit aperture 23 (FIGS. 1 and 2).

The release region 22 may be positioned over the exit aperture 23 so that the loose seeds in the release region 22 can follow a direct and unimpeded path to the exit opening of the seeds 23. This arrangement may improve an accuracy in the spacings between the seeds in soil, since any obstacle or deviation in the seed path may cause a disordered movement of, or spacing between, the seeds, which may counteract the efforts of organizing and precisely spacing the seeds in the holes 3 of the rotational disk 2.

In some examples, as shown in FIG. 19, the seed ejector 20 may completely cover at least one hole 3 of the rotational disk 2 as the hole 3 passes under the seed ejector 20. In additional examples, as shown in FIGS. 20-22, the seed ejector 20 may cover only a portion of the hole 3 as the hole passes under the seed ejector 20.

Therefore, in some embodiments of the present disclosure, the disclosed pneumatic seed meter 1 may be capable of eliminating or at least reducing the limitations and problems of conventional seed meter technologies.

The present disclosure provides a number of potential improvements for pneumatic seed meters. These improvements may be achieved at various portions of the seed path inside the seed meters, including from the seed supply to the seed deposition stage.

In some examples, the concepts of the present disclosure may be employed for greater control of seed movement in the singularization stage. This control in the seed supply may be achieved by the actuation of the air exhaust element 13 in conjunction with the inner conveyor tube 18. For example, the air exhaust element 13 and/or the inner conveyor tube 18 may inhibit airflow of the feed pipes of the planter from reaching the singulation chamber of the seed meter 1, which may inhibit the turbulent flow of seeds and may reduce or eliminate the occurrence of doubles and failures.

In addition, the sealing structure 5, which may be a single, unitary piece, may act in conjunction with the rotational disk 2 to define the seed containment chamber 6. The seed containment chamber 6 at least partially defined by the sealing structure 5 may not only prevent leakage of seeds from the seed meter 1, but may also facilitate coupling of the seeds to the rotational disk 2, since the seed containment chamber seeds 6 may restrict the movement of the seeds into peripheral regions of the seed path of the rotational disk 2.

In addition, as discussed above, the seed meter 1 of the present disclosure may also include a debris remover 24 with pins 26 that may be configured for applications with small seeds and/or brittle seeds. The debris remover 24 of the present disclosure may include tips 26, which may be formed of an abrasion-resistant material. The tips 26 may have curved or angled geometries to penetrate the holes 3 of the rotational disk 2 to remove potential debris trapped in the holes 3, which might otherwise impair the coupling of the seeds in the holes 3 and lead to failures. The abrasion-resistant material of the tips 26 may enable the tips 26 and/or the rotational disk 2 to have a longer life.

As further described above, the seed ejector 20 may be provided to improve the decoupling of the seeds from the disk at the appropriate time, which precedes the deposition of the seed in the soil. The curved geometry of the seed ejector 20 may correspond to the circular trajectory of the seeds on the rotational disk 2, thus inhibiting the abrupt removal of the seeds from the holes 3 that might otherwise occur with a linear penetration of the hole by an ejector. These potential improvements may reduce or eliminate spacing problems in the stage of seed deposition in the soil.

In addition, the seed ejector 20 of the present disclosure may be installed and effectively operated at several points in the seed meter 1. For example, the seed ejector 20 may be installed in the low-pressure region 21, at the interface of the low-pressure region 21 with the seed release region 22, or in the seed release region 22.

Therefore, the disclosed seed meter 1 may achieve a number of improvements over conventional seed meters. These potential improvements may influence the operation of the meter over one or more portions of the entire seed path 4 therein, from the time of entry of the seeds and their storage in the meter, via the air exhaust element 13 and the inner conveyor tube 18, through step of coupling the seeds into the holes 3 of the rotational disk 2 by means of the sealing structure 5 and finally, in the step of depositing the seeds, which may be improved by the action of the seed ejector 20 and the debris remover 24 as described above.

These solutions may considerably improve the effectiveness of seed meters compared to conventional seed meters, especially when it comes to the deposition of small seeds. Although particular examples have been disclosed and shown herein, the elements and concepts described in the present disclosure may be adapted for use with other pre-existing seed meters.

Specifically, for canola, which has a relatively high-cost compared to other seeds, the potential improvements described herein and achieved by embodiments of the present disclosure may provide significant financial benefits, such as to farmers.

Thus, the present disclosure may have certain advantages over conventional seed meters and may contribute to the technological development in agriculture, such as in the industry of precision planting of small seeds and fine grains.

While the present disclosure has been specifically described with respect to particular embodiments, it should be understood that variations and modifications will be apparent to those skilled in the art and may be made without departing from the scope of protection of the present disclosure. Accordingly, the scope of protection is not limited to the embodiments described, but is limited only by the appended claims, the scope of which must include all equivalents.

1. A pneumatic seed meter, comprising:
a rotational disk including a plurality of radially disposed holes, wherein the holes define a seed path when the rotational disk rotates; and
a sealing structure located adjacent to and against the rotational disk in a position to prevent seed leakage, wherein the sealing structure at least partially defines a seed containment chamber for containing seeds therein.

2. The pneumatic seed meter of claim 1, wherein the sealing structure is coupled to the rotational disk by a support element, forming a unitary, integral device.

3. The pneumatic seed meter of claim 1, wherein the sealing structure comprises a shell structure including a concave chamber, wherein the concave chamber is positioned against a front surface of the rotational disk to define the seed containment chamber within the concave chamber and against the front surface of rotational disk.

4. The pneumatic seed meter of claim 1, wherein the sealing structure comprises air passage openings each having dimensions smaller than an average diameter of seeds to be deposited by the pneumatic seed meter.

5. The pneumatic seed meter of claim 1, further comprising a seed meter housing, wherein the sealing structure is further coupled to the housing.

6. The pneumatic seed meter of claim 1, wherein the sealing structure comprises sealing elements located along on edge portions of the sealing structure, wherein the sealing elements are positioned to abut and slide against a front surface of the rotational disk.

7. A pneumatic seed meter, comprising:
a seed feed inlet positioned to convey seeds into the pneumatic seed meter; and
an air exhaust element positioned at the seed feed inlet, wherein the air exhaust element comprises a sidewall that is configured to allow passage of air therethrough while inhibiting the passage of seeds therethrough, wherein at least a portion of the sidewall is non-parallel.

8. The pneumatic seed meter of claim 7, wherein the air exhaust element comprises has an upper aperture having an upper perimeter and a lower aperture having a lower perimeter, wherein the upper perimeter is larger than the lower perimeter.

9. The pneumatic seed meter of claim 7, further comprising a protective casing at least partially surrounding a periphery of the air exhaust element.

10. The pneumatic seed meter of claim 7, wherein the air exhaust element comprises vertically oriented apertures in the sidewall that are sized to convey airflow while inhibiting the passage of seeds therethrough.

11. A pneumatic seed meter, comprising:
a rotational disk including a plurality of radially disposed holes, wherein the holes define a seed path when the rotational disk rotates; and
a seed ejector disposed adjacent to a front face of the rotational disk over a portion of the seed path, wherein at least a portion of the seed ejector is positioned over a low-pressure region of the rotational disk.

12. The pneumatic seed meter of claim 11, wherein the seed ejector is removable and replaceable according to the type of seed to be deposited by the pneumatic seed meter.

13. The pneumatic seed meter of claim 11, wherein the seed ejector has a curved interface that is positioned over the front face of the rotational disk such that the curved interface gradually enters the seed path when the rotational disk rotates.

14. The pneumatic seed meter of claim 13, wherein the curved interface of the seed ejector has a predefined geometry according to a circular trajectory of the seed path.

15. The pneumatic seed meter of claim 11, wherein the seed ejector is located within the low-pressure region.

16. The pneumatic seed meter of claim 11, wherein at least a portion of the seed ejector is located in a border region of the low-pressure region.

17. The pneumatic seed meter of claim 11, wherein at least a portion of the seed ejector is located in a region of transition from the low-pressure region to a seed-release region.

18. The pneumatic seed meter of claim 11, wherein at least a portion of the seed ejector is located within a seed release region.

19. The pneumatic seed meter of claim 11, wherein the seed ejector is coupled to the rotational disk via a guide system.

20. A pneumatic seed meter, comprising:
a rotational disk including a plurality of holes disposed radially in a peripheral region of the rotational disk; and
a debris remover including protrusions, wherein each of the protrusions exhibits a complementary shape relative to at least a portion of the holes of the rotational disk, and wherein each of the protrusions comprises a tip made of an abrasion-resistant material.

21. The pneumatic seed meter of claim 20, each of the tips of the debris remover comprises a base portion and an end portion, wherein the end portion of each of the tips is angled relative to the corresponding base portion.

22. The pneumatic seed meter of claim 20, wherein each of the tips of the debris remover is curved.

23. The pneumatic seed meter of claim 20, wherein the tips of the debris remover have a sufficient length to traverse the holes of the rotational disk when removing debris from the holes.

24. The pneumatic seed meter of claim 20, wherein the abrasion-resistant material of the tips comprises at least one of: a metal material or a ceramic material.

25. The pneumatic seed meter of claim 20, wherein each of the tips is attached to the debris remover.

26. The pneumatic seed meter of claim 20, wherein the tips of the debris remover are interconnected to each other, forming a metal scaffold located inside the debris remover.

27. The pneumatic seed meter of claim 20, wherein each of the tips is made of a same material as the debris remover.

28. The pneumatic seed meter of claim 20, wherein each of the tips of the debris remover has a tip diameter that is at least 10% smaller than a hole diameter of each of the holes of the rotational disk.

29. The pneumatic seed meter of claim 28, wherein each of the hole diameters of the holes of the rotational disk is in a range of about 0.5 mm to about 2.0 mm.

30. The pneumatic seed meter of claim 28, wherein each of the hole diameters of the holes of the rotational disk is predetermined for capturing canola seeds.
